(19) United States
(12) Patent Application Publication
(10) Pub. No.: US 2021/0233009 A1
(43) Pub. Date: Jul. 29, 2021

(54) SYSTEMS AND METHODS FOR PROVIDING HUMAN RELATION IMPROVEMENT

(71) Applicant: Kfir Baranes, Lake Worth, FL (US)

(72) Inventor: Kfir Baranes, Lake Worth, FL (US)

(21) Appl. No.: 16/752,453

(22) Filed: Jan. 24, 2020

(51) Int. Cl. G06Q 10/06; G06Q 50/00

(52) U.S. Cl. CPC G06Q 10/06398; G06Q 50/01

(57) ABSTRACT

A system for providing human relation improvement includes at least a server operating a communications network configured to be communicatively coupled to a database for storing first user records; and a processor configured for: creating the first user record and storing first user data in the first user record; receiving from a second user remote computing device, first user core value input for each of a plurality of first user core values; storing the first user core value input associated with the first user; calculating a first user rating; providing a first user profile including the first user rating; providing, graphical representations each suggesting an emotion for the second user to select a user core value input and wherein each graphical representation is assigned a predetermined worth; and increasing, by a predetermined amount, the first user rating upon receiving completion data of an improvement action by the first user.

### CROSS-REFERENCE TO RELATED APPLICATIONS

Not applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to social intelligence computing, and more specifically, systems and methods for providing human relation improvement.

### BACKGROUND

Social intelligence relates to the capacity of an individual to be aware of not only their interactions with other individuals but also their self-evaluation based on experiences associated with various social settings. Social intelligence is essential for individuals that aspire to improve various components of their lives, such as, but not limited to, professional advancement, social networking, and overall likeability.

Currently, social behaviors can be monitored when manifested via social computing components such as blogs, emails, social networks, and the like. However, the use of mobile computing devices is more popular than ever, resulting in a demand for analytics and micro-analytics relating to interactions occurring in everyday life. For example, an individual with a career that is significantly dependent upon social reputation, such as a local politician, requires constant data and feedback relating to both the approval of the overall community and specific interactions with particular individuals within the community.

Companies and organizations spend countless hours attempting to generate metrics and analytics relating to social interactions occurring within local communities and the social world altogether. However, a commonly associated issue is the inability to extract data specific to particular social interactions and generate metrics or analytics representing how the particular social interactions affect the involved individuals, along with a system utilizing these metrics or analytics in the form of a connected network. In other words, there is a demand for a centralized system or platform configured to acquire data associated with a particular individual and their interactions with other individuals in order to generate metrics or analytics associated with the particular individual that reflects their moral character or other attributes such as timeliness, cleanliness, etc. Furthermore, the generated metrics and analytics should be configured to account for other character assessments associated with the particular individuals and be maintained on a profile in order to provide the public with assessments necessary to draw conclusions regarding the particular individual. Therefore, there exists a need for improvements over the prior art and, more particularly, for a more efficient way to improve human relations via a network.

### SUMMARY

Systems and methods relating to providing improved human relations are disclosed. This Summary is provided to introduce a selection of disclosed concepts in a simplified form that are further described below in the Detailed Description, including the drawings provided. This Summary is not intended to identify key features or essential features of the claimed subject matter. Nor is this Summary intended to be used to limit the claimed subject matter's scope.

In one embodiment, a computer-implemented method for providing human relation improvement is disclosed. The method includes creating a first user record for a first user and storing the first user data associated with the first user in the first user record. The method further includes receiving, over a communications network, from a second user remote computing device, a first user core value input for each of a plurality of first user core values about the first user. The method then stores, in the first user record, the first user core value input associated with first user; calculating the first user rating based on the first user core value input from at least one-second user remote computing device; and providing, to at least one of a first user remote computing device and the second user remote computing device, a first user profile having a first graphical representation of the first user rating. In one embodiment, a system for providing human relation improvement configured to achieve the computer-implemented method is disclosed. The system is configured to operate over a communications network configured to communicatively couple a plurality of mobile computing devices each associated with a particular user. Each computing device including a graphical user interface configured to visually depict the first graphical representation of the first user rating.

In one embodiment, a system for providing human relation improvement is disclosed. The system includes at least a server operating a communications network configured to be communicatively coupled to a database for storing a plurality of at least first user records; memory; and a processor configured for: creating the first user record for a first user and storing first user data associated with the first user in the first user record; receiving, over a communications network, from a second user remote computing device, first user core value input for each of a plurality of first user core values about the first user; storing, in the first user record, the first user core value input associated with first user; calculating the first user rating based on the first user core value input from at least one-second user remote computing device; providing, to at least one of a first user remote computing device and the second user remote computing device, a first user profile having a first graphical representation of the first user rating; providing, a plurality of second graphical representations each suggesting an emotion for the second user to select to provide the least one first user core value input of the first user and wherein each second graphical representation is assigned a predetermined worth; and increasing, by a predetermined amount, the first user rating upon receiving completion data of an improvement action by the first user.

In one embodiment, the method includes a rating associated with each core value, wherein each core value is defined as a first function of the first user core value input received, the total number of core values, and the total number of second users providing first user core value input. In one embodiment, a plurality of statistical models may be utilized in order to generate the core value or any relevant data associated with the core value, such as but not limited to, an average, median, mode, average of the average, or any other applicable statistical calculations.

In one embodiment, the first graphical representation for the first user rating may be displayed as a percentage value. In one embodiment, the first graphical representation may be displayed by at least a partially enclosed ring wherein the shape of the ring corresponds with the percentage value. In one embodiment, the first graphical representation may be directly correlated to an augmented expression such as an interactive emoji, a bitmoji, or any other personalized avatar configured to manifest emotions.

In one embodiment, the method further includes providing, over the communications network to the second user remote computing device, a plurality of second graphical representations each providing an impression related to value for the second user to select to provide the least one first user core value input of the first user and wherein each second graphical representation is assigned a predetermined value.

In one embodiment, the method further includes a second user configured to provide user preferences on one of the mobile computing devices via a swiping gesture, push, or any other applicable means of indicating user preferences on a graphical interface resulting in an entertaining experience for the second user.

In one embodiment, the method includes receiving from the second user a request message to interact with a particular first user; sending to the particular first user's first user remote computing the request message for the first user to at least one of accept and reject the request message to interact; receiving from the particular first user's first user computing device at least one of a denial message and approval message; denying access by the second user computing device to the particular first user's first user profile so that the second user cannot provide first user core value input if the denial message is received, and allowing access by the second user computing device to the particular first user's user profile so that the second user may provide first user core value input if the approval message is received. Access or denial of the second user to the first user's profile may be managed by an access control component hosted by an entity associated with the communications network.

In one embodiment, the method further includes counting as a first user interaction each time the first user accepts the approval message from one of the second users and storing the total number of first user interactions in the first user record.

In one embodiment, the method further includes receiving filtering criteria, over the communications network, from the second user remote computing device; determining the first users matching the filtering criteria received; calculating a first user listing score for each of the first users matching the filtering criteria received, wherein the first user listing score is a second function of the first user rating and user interactions; and displaying on at least one of the first user remote computing device and second user remote computing device, a list of first users profiles matching the filtering criteria and wherein the list is arranged in a predetermined pattern corresponding to each first user listing score.

As described herein, filtering criteria may include, but are not limited to, geographic distance between the first and second user, user age demographic, gender, profession, trade, hobbies, network, or any other applicable filtering factors.

In one embodiment, the first user data further includes at least one of a first user first name, a first user last name, a first user telephone number, a first user email address, a first user physical mailing address, and, a first user password, a first user occupation, a first user age, and a first user sex, number of first user interactions and a first user listing score. In one embodiment, the first user rating is not provided to, at least one of the first user computing device and second user computing device, until first user core value input is received from at least a predetermined minimum threshold of second user remote computing devices.

In one embodiment, the method further includes increasing the first user rating by a predetermined amount upon receiving completion data of an improvement action by the first user. As described herein, an improvement action may be fulfillment or completion of an exercise, event, course, set of instructions, or beneficial component associated with a core value as described herewith. Data relating to the improvement action or said completion thereof might be provided by a provider remote computing device configured to host, facilitate, or monitor the applicable event, course, or exercise. The increase or decrease to the first user rating may be accomplished by the server based on analytics or metrics provided by the provider remote computing device.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 a diagram of an operating environment that supports applications, methods, and systems for providing improved human relations according to one embodiment of the invention;

FIG. 2A is a diagram illustrating an exemplary method for providing improved human relations, according to an example embodiment;

FIG. 2B is a diagram illustrating an exemplary method for providing improved human relations relating to how the user may increase the user rating and core value by completing an improvement action or a suggestion, according to an example embodiment;

FIG. 2C is a diagram illustrating an exemplary method for providing improved human relations relating to how the first user may approve or deny another user access to provide core value input about the second user, according to an example embodiment;

FIG. 3A is an exemplary diagram illustrating the data flow of the exemplary method for providing improved human relations wherein a listing of users matching specific criteria is generated, according to an example embodiment;

FIG. 3B is an exemplary diagram illustrating the data flow of the exemplary method for providing improved human relations wherein a user rating is generated, according to an example embodiment;

FIG. 3C1 is an exemplary diagram of a first portion of a graphical user interface that may be provided for providing search criteria, according to an example embodiment;

FIG. 3C2 is an exemplary diagram of a second portion of the graphical user interface from FIG. 3C1 that may be provided for providing search criteria, according to an example embodiment;

FIG. 3C3 is an exemplary diagram of a first portion of a graphical user interface that may be provided for providing search criteria, according to an example embodiment;

FIG. 3C4 is an exemplary diagram of a second portion of the graphical user interface from FIG. 3C3 that may be provided for providing search criteria, according to an example embodiment;

FIG. 3D is an exemplary graphical user interface that may be provided for viewing a first user profile having the first user rating of a first user, according to an example embodiment;

FIG. 3E1 is an exemplary graphical user interface that may be provided for viewing a list of multiple first user profiles having the first user rating, according to an example embodiment;

FIG. 3E2 is an exemplary graphical user interface that may be provided for viewing a list of multiple first user profiles having the first user rating, according to an example embodiment;

FIG. 3F is an exemplary graphical user interface that may be provided for viewing multiple icons for illustrating first user core value data and for receiving first user fore value data, according to an example embodiment;

FIG. 3G1 is a first portion of an exemplary graphical user interface that may be provided for viewing multiple icons or second graphical representations providing impression related to value for the second user to select to provide core value input, according to an example embodiment;

FIG. 3G2 is a second portion of an exemplary graphical user interface that may be provided for viewing and selecting multiple icons or second graphical representations providing impression related to value for the second user to select to provide core value input, according to an example embodiment;

FIG. 3H1-3H10 are exemplary graphical user interfaces each displaying icons or second graphical representations providing an impression related to value for the second user to select to provide core value input, according to an example embodiment; and,

FIG. 4 is a block diagram depicting a system including an example computing device and other computing devices.

Like reference numerals refer to like parts throughout the several views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system and method for improving human relationships. The system includes at least a server operating over a communications network and communicatively coupled to a plurality of mobile computing devices associated with users of the network. The network is configured to house and maintain profiles associated with the users, each including one or more core values associated with the user. The system is configured to provide real-time data relating to the core value and/or the user profiles via one or more graphical user interfaces based on received impressions or perceptions relating to a particular user used to generate scoring that results in not only an entertaining user experience but more importantly an improved method for providing human relation improvement. The combination of the aforementioned along with the methods of collecting and maintaining core value data in order to generate scorings and rankings associated with the user profiles based on the core value data and various embodiments allow for real-time data and analytics relating to core values relating to a particular user and more accurate and enhanced character information relating to the particular user provided to other users operating on the communications network. They disclose embodiments improve over the prior art by providing a better way to improve human interaction. The disclosed embodiments improve over the prior art by providing graphical representations that provide entertaining experiences or impressions of one user's experience with another. The disclosed embodiments improve over the prior art by providing graphical representations, each suggesting an emotion for the second user to select which is assigned a predetermined worth. These graphical user interfaces allow a second user to select images that reflect or are associated with how a first user makes a second user feel during the interaction between the users.

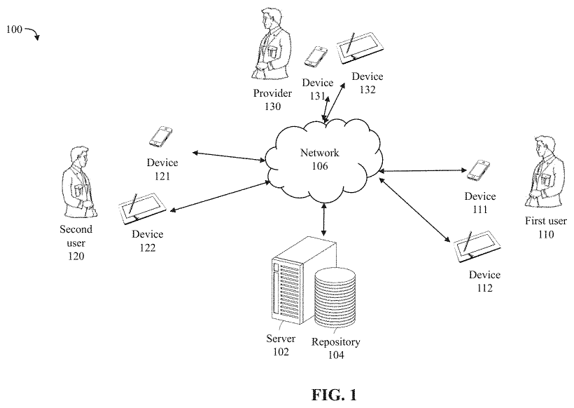

Referring now to the Figures, in which like reference designators refer to like elements, there is shown in FIG. 1 an illustration of a block diagram showing a system for human relation improvement 100 in which the techniques described may be practiced according to certain embodiments. In one embodiment, system 100 may be implemented in hardware, software, or a combination of hardware and software. In some embodiment, the various components of system 100 are implemented at least partially by hardware at one or more computing devices, such as one or more hardware processors executing instructions stored in one or more memories for performing various functions described herein. For example, descriptions of various components (or modules) as described in this application may be interpreted by one of skill in the art as providing pseudocode, an informal high-level description of one or more computer structures. The descriptions of the components may be converted into software code, including code executable by an electronic processor. System 100 illustrates only one of many possible arrangements of components configured to perform the functionality described herein. Other arrangements may include fewer or different components, and the division of work between the components may vary depending on the arrangement.

System 100 includes a server 102 configured to host a communications network 106 and be communicatively coupled to all components of system 100. In one embodiment, system 100 includes a repository/database 104, a first user 110 associated with a first mobile computing device 111, a second user 120 associated with a second computing device 121. In one embodiment, system 100 further includes a provider 130 associated with a third computing device 131.

The system 100 is configured to provide computer-implemented methods for providing human relation improvement. As described herein, a core value is a representation or subset of a personality attribute, temperament, assessment, evaluation, or quality of a particular individual. A core value may also be derived based on an interaction or subsequent impression caused by an exchange between the particular individual and one or more other individuals in a social, professional, or any other applicable environment. A core value may also be derived from opinions, statements, or applicable user activity associated with the particular individual occurring over a social network, media platform, or any other applicable source commonly frequented by the individual to express perspective. Examples of core values may include but are not limited to, honesty, integrity, compassion, professionalism, punctuality, or any other ascertainable behavior based on the statements, opinions, or interactions of the particular individual with themselves or another.

Provider 130 may be a third-party entity configured to provide external information to server 102 to be stored on repository/database 104. Examples of computing device 102 include a laptop computer, a tablet computer, a smartphone, a desktop computer, a Personal Digital Assistant (PDA), and any other mechanism used to access networks or applications. An example of an application that executes on a computing device as described herein may be a mobile or web application hosted by server 102 installed on the computing device, allowing users 110 and 120 to interact with a plurality of graphical user interfaces in order to access applicable data within system 100. Computing devices 122 and 131 are presented as a representation that users 110 and 120 may perform activities over the network via more than one computing device subject to the computing device being associated with one user profile at a time. This prevents users 110 and 120 from operating more than one account hosted by server 102 linked to a user profile and providing false information to system 100 in order to boost or reduce scoring associated with a user profile. In one embodiment, system 100 may include an administrator component configured to link a user profile with a maximum amount of computing devices (for example, maximum three registered devices) based on a unique code or identifier provided to first user 110 or second user 120, which is requested upon attempting to access system 100. In one embodiment, users 110 and 120 may be provided access to their respective computing devices via the administrator component by providing facial data to the applicable computing device for device authentication and subject identification.

For example, first user 110 may register for an account upon downloading executable software associated with system 100 from an application distribution platform, typically operated by the owner of the mobile operating system (OS), such as the Apple App Store, Google Play, Amazon Appstore, BlackBerry AppWorld, Nokia Store, Windows Phone Marketplace, and the like. Upon providing applicable information such as name, age, occupation, and any other relevant personal information, server 102 stores this information in repository/database 104 and verifies the accuracy of the received information in order to prevent the creation of a false or misleading account. In one embodiment, the accuracy of information received from first user 110 may be verified via applicable authorized social network accounts associated with first user 110, such as Facebook, LinkedIn, or any other applicable entity configured to verify personal information. In one embodiment, the personal information may be provided or verified by provider 130. Upon proper verification, a user profile and/or account associated with first user 110 is created by server 102, including a user record based on the verified personal information. However, the generated user profile will not include a core value input because the core value input may only be provided by second user 120, provider 130, or a user distinct from first user 110. In one embodiment, first user 110 may receive an invitation to create an account in system 100 from second user 120 or provider 130. For example, second user 120 may have recently met first user 110 for the first time, or both parties may have just finished a business transaction. Second user 120 may log into system 100 via second computing device 121 and generate a core value input associated with first user 110 based on the impression or perception that first user 110 gave the second user 120. Based on whether server 102 detects an account associated with first user 110, server 102 may automatically send first user 110 an invitation to download software associated with system 100. In one embodiment, personal information associated with first user 110 may be provided by second user 120 or provider 130 and included in the invitation, subject to the aforementioned verification step.

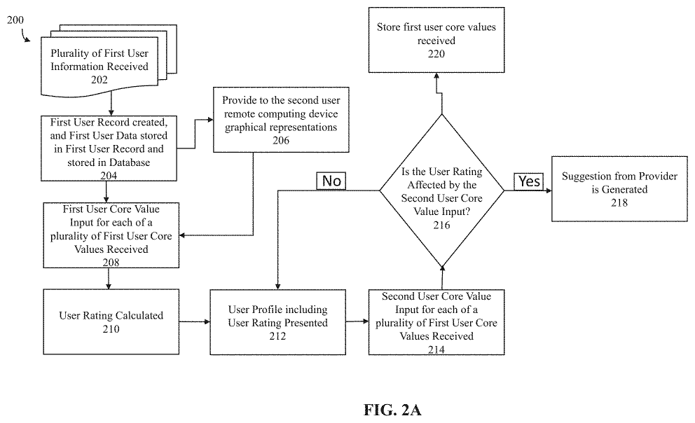

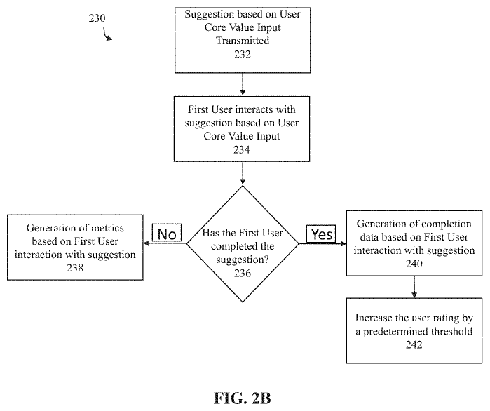

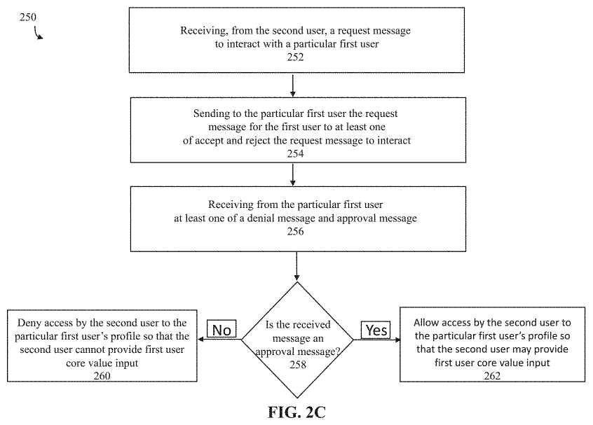

Referring now to FIGS. 2A-C and 3A-B, a method 200 for improving human relation in system 100 is depicted. In step 202, a plurality of first user information is received. In one embodiment, the plurality of first user information is received from the first user 110, the second user 120, the provider 130, or any other applicable source configured to provide verified information relating to first user 110. The plurality of first user information may include the first name, last name, telephone number, email address, physical address, age, sex, listing score, number of interactions, occupation, memberships, hobbies, skillsets, financial information (such as credit demographic), and any other applicable information that may be related to the core values of an individual.

Next, in step 204, an account or profile, including the plurality of first user information, is generated or created and stored in repository/database 104. The user account may further include a plurality of empty slots configured to be filled with user core value inputs provided by second user 120 or provider 130.

In one embodiment, while the generated user profile is stored in repository/database 104, the administrator component must verify whether the plurality of first user information is accurate (via interactions with entities that may be outside of system 100) before the user profile may be visible to second user 120.

Next, in step 206, the system is configured for providing a user interface for the second user remote computing device 121, 122, to provide core value input for each of a plurality of first user core values about the first user. As mentioned above, the core value input is associated with the core value. It may also be derived based on an interaction or subsequent impression caused by an exchange between the particular individual and one or more other individuals in a social, professional, or any other applicable environment. A core value may also be derived from opinions, statements, or applicable user activity associated with the particular individual occurring over a social network, media platform, or any other applicable source commonly frequented by the individual to express perspective. Examples of core values may include but are not limited to, honesty, integrity, compassion, professionalism, punctuality, or any other ascertainable behavior based on the statements, opinions, or interactions of the particular individual with themselves or another.

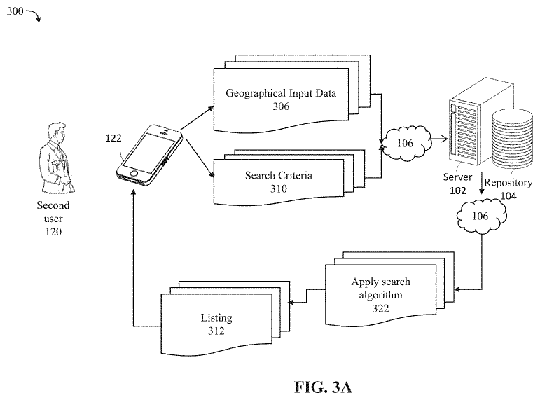

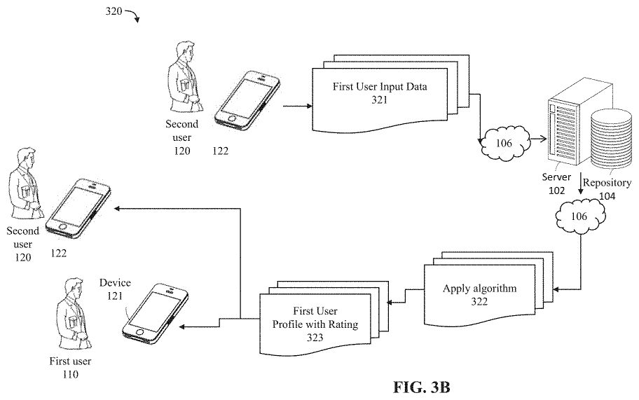

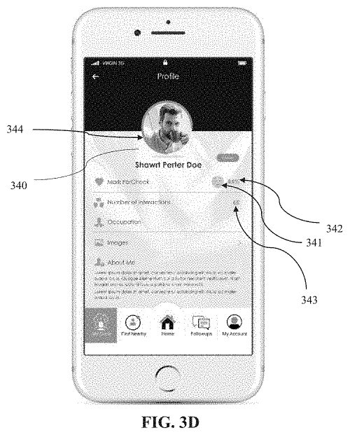

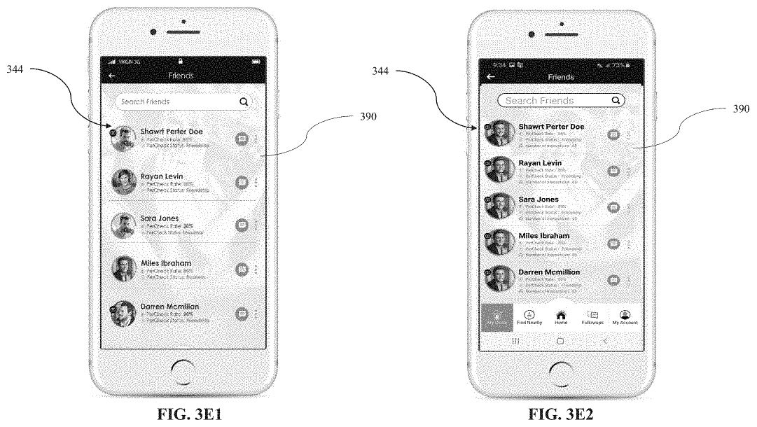

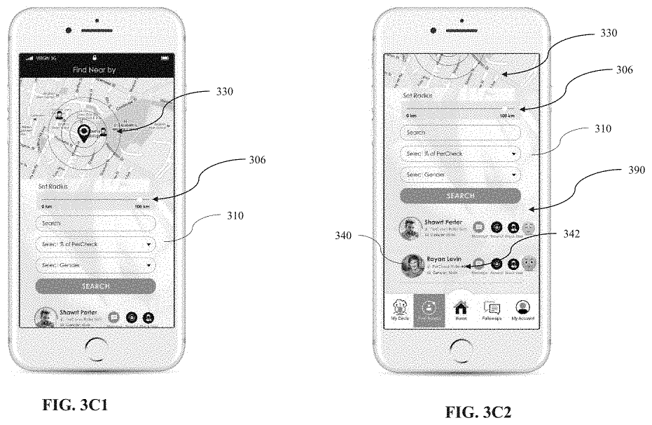

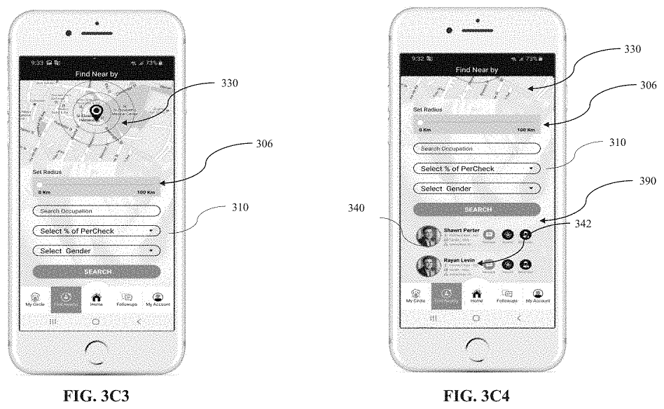

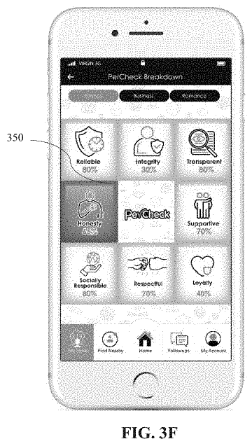

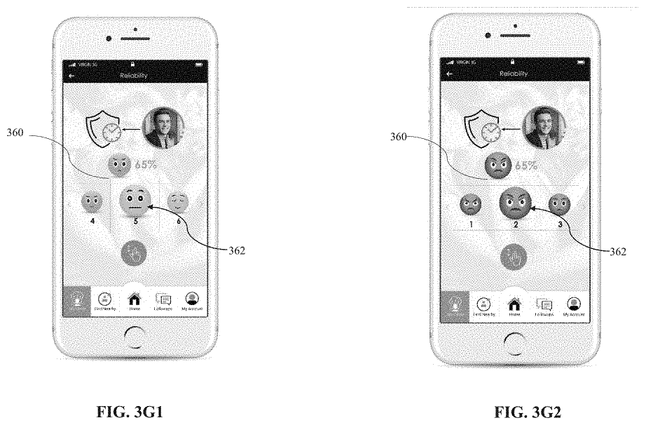

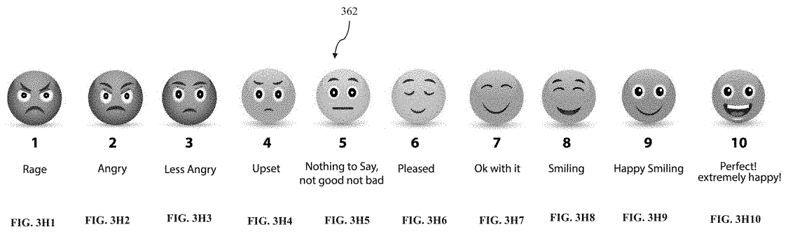

Core value inputs may be provided via gestures such as, but not limited to, swiping, swipe, push, pushing, or any other applicable type of movement along the graphical user interface indicating one or more preferences of second user 120. In one embodiment, core value inputs may be represented on the graphical user interface of computing devices via emojis, bitmojis, or any other symbol, icon, or avatar reflection of a reaction or emotions 362 as illustrated in FIGS. 3G1-3G2 and 3H1-10.

For example, core values may include reliability, honesty, integrity, supportiveness, Transparency, respectfulness, loyalty, etc. As illustrated in FIG. 3F. However, other core values may be included and are within the spirit and scope of the present invention. In operation, a second user may select one of the core values icons 350 illustrated on in FIG. 3F, for example. After selecting one of the core value icons, then the system may be configured to provide one of the graphical interfaces 360 illustrated in FIG. 3G1 and FIG. 3G2. FIG. 3G1 is a first portion of an exemplary graphical user interface 360 that may be provided for viewing multiple icons or second graphical representations providing impressions related to value for the second user to select to provide core value input. FIG. 3G2 is a second portion of an exemplary graphical user interface 360 that may be provided for viewing and selecting multiple icons or second graphical representations providing impression related to value for the second user to select to provide core value input, according to an example embodiment. A user may use a swiping gesture or other types of gestures to toggle between the variety of different icons illustrated in FIGS. 3G1 and 3G2. As mentioned above, each of the icons may illustrate an emotion the second user associated with the first user. In non-limiting embodiments, the graphical representations of emotions that the second user may select from for rating the first user's core values associated with the first user may be provided to the second user, as illustrated in FIGS. 3G-3H. However, other types of embodiments that provide an impression may also be used and are within the spirit and scope of the present invention.

Next, in step 208, a first user core value input 321 for each of a plurality of first user core value inputs is received from the second user device 122 of the second user 120. In one embodiment, the first user core value input 321 may be received from and based on the second user interactions with a plurality of graphical representations. In one embodiment, a first user core value input received from the interaction with the graphical representation reflects an impression or perception received by second user 120 or provider 130 based on an interaction with first user 110. For example, if first and second users 110 and 120 recently entered into a business transaction and second user 120 received the impression that first user 110 is an honest, intelligent, and punctual individual based on the business transaction, second user 120 would provide 3 separate core value inputs associated with first user 110. However, the core value inputs would not be displayed on the user profile of first user 110 until a minimum predetermined threshold of users other than first user 110 operating on network 106 entered the same or similar core value inputs. For example, in one embodiment, the minimum predetermined threshold maybe three users to protect the anonymity of each of the second users.

In one embodiment, server 102 is configured to associate words and word strings in a language by analyzing word formations around a word or word string to identify other words or word strings that are equivalents or near-equivalents semantically. For example, if second user 120 provided the core value input indicating that first user 110 was honest and a user besides first and second users 110 and 120 provides core value input indicating that first user 110 is trustworthy, then server 102 would be able to interpret these core values as similar and increment a core value input count accordingly. In one embodiment, if the core value input count for a particular core value input reaches three, then the core value input is enabled to be visible on the user profile of first user 110 to other users. In one embodiment, core value inputs are provided to system 100 via second user 120, providing a plurality of inputs whether in response to a plurality of options for core values provided to second user 120 by server 102 or textual inputs reflecting core values (keyboard submissions). In one embodiment, core value inputs may be provided via gestures such as, but not limited to, swiping, pushing, or any other applicable type of movement along the graphical user interface indicating one or more preferences of second user 120. In one embodiment, core value inputs may be represented on the graphical user interface of computing devices via emojis, bitmojis, or any other symbol, icon, or avatar reflection a reaction or emotions 362 as illustrated in FIGS. 3G and 3H. For example, second user 120 may have developed uneasy or concerned impressions based on their interaction with first user 110, which may be represented by a selected emoji or avatar displaying a grimacing face, as illustrated in FIG. 3H. In one embodiment, reaction 362 may be configured to receive inputs from the second user via the graphical user interface in order to provide the core input value. In one embodiment, reaction 362 may be extracted from image or video data captured by one or more cameras or sensors associated with a client device.

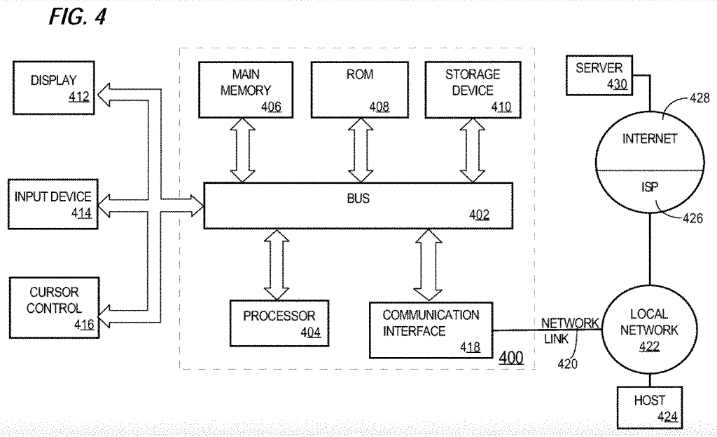

At step 210, server 102 performs data flow 320 by calculating the user rating for the first user based on the first user input data relating to second users providing core value inputs being satisfied. In one embodiment, calculation of the user rating is updated in real-time based on newly received core value inputs from verified second users. The user rating may be calculated by applying an algorithm 322 and presented in various methods and embodiments. In one embodiment, the user rating is defined as a first function of received core value inputs, the total number of core values associated with first user 110, and the total number of other users providing core value inputs. In one embodiment, the user rating is defined as the sum of all the first user core value input received divided by the total number of core values rated by the second users or the user rating may be an aggregation of the average of each core value input for each applicable core value associated with the first user. In one embodiment, the calculation of the user rating is based on a plurality of statistical models utilizing the received core value inputs. In one embodiment, varying weights may be attributed to various core values resulting in the calculation of the user rating being attributed to core values that are weighted more heavily than others. The varying and allocation of weights to core values may be based on the context of the values and the capacity that they are being applied to in the user profile. For example, if the first user 110 is a surgeon, the core value of attentiveness is assigned a higher weight than the core value of punctuality when calculating the user rating. In one embodiment, the user rating is represented on a graphical user interface via a percentage directly associated with the user profile. For example, the icon or second illustrated in FIGS. 3H1-3H10 are each assigned a number 1-10, respectively. In this example, a first-second user selects the icon illustrated in FIG. 3H3 to describe the impression first user X gives the second user associated with a particular core value, which has a value of 3. A second user selects the icon illustrated in FIG. 3H-4 to describe the impression first user X gives the second user associated with a particular core value, which has a value of 4. A third second user selects the icon illustrated in FIG. 3H 5 to describe the impression first user X gives the second user associated with a particular core value, which has a value of 5. In one embodiment, the system may apply a first function to calculate the first user rating. As mentioned above, in one embodiment, the first function of the first user core value input received the total number of core values, and the total number of second users providing first user core value inputs. In one embodiment, the function may an average of the values of core value input received. In the example above, the first user core value rating for the first user maybe 4 (Sum of all the input/total number of users) ((3+4+5)/3). However, a variety of functions may be used and are within the spirit and scope of the present invention.

Each of the icons are innovative because it allows the user to select an icon that most closely illustrates how the first user made the second user feel during the interaction between the first and second user. This allows the second user to select an icon or graphical representation of how the second user feels during or after the second user's interaction with the first user, which may be a lot easier and different than simply assigning a value. For example, if the second user is to provide input for a first user's punctuality, and the first user was two hours late or never even showed up, and the second was enraged, then the second user may select the icon illustrated in FIG. 3H1.

Next, in step 212, the user profile 340 may be provided, including a user rating 342, as illustrated in FIG. 3D is presented. FIG. 3B illustrates that the data 323 associated with the first user profile may be provided to either the first user or second user. In one embodiment, user rating may be associated with the core value input received.

In one embodiment, the user rating calculated by the system is represented on a graphical user interface via a circular or ring-like structure 344 that is partially enclosed in which the enclosing corresponds to the percentage value associated with the user rating. For example, if the user rating is fifty percent or 5 out often, then the user rating may be represented by a half-ring that is 50% of the full ring. The ring-like structure may support illuminating, glowing, flashing, or any other functionality to illustrate a change sustained by the user rating.

In one embodiment, the second user may search for the first user based on other users associated (via friendship, connection, or any other applicable social network linking) with the first user via an aggregated friends list, as illustrated by FIG. 3E1 and FIG. 3E2, or the second user may be provided a subset of users and their respective social networks based on one or more of the filtering criteria. In another embodiment, if the user rating is 40% or 4 out of 10, then the user rating may be illustrated with a percentage value 342, as illustrated in FIG. 3D. Additionally, in other embodiments, the system may be configured to illustrate the user rating via an icon 341. For example, If the user rating has been calculated as a 70% rating or 7 out of 10, then the system may be configured to illustrate the user rating with the icon illustrated in FIG. 3H7.

In step 214, a subsequent second user provides core input values relating to the first user. In one embodiment, the minimum amount of second users, maybe three separate users. This allows the second user to have some type of anonymousness so that the first user does not know which second user rated the first user and allows the second user to take comfort in the first user, not knowing which second user provided a core input value that alters the user rating. In step 216, server 102 makes a determination as to whether or not the core input values change the real-time calculation of the user rating. If not, then step 212 occurs, and the user rating is presented via the user profile. If so, then step 218 occurs in which a suggestion for the first user associated with the relevant core input value is generated by provider 130. In step 220, the newly provided user core values are stored; however, this step may occur during the determination at step 216. In one embodiment, users may view an overall breakdown of each core value subject to the predetermined threshold being satisfied, which presents a percentage for each core value relating to the first user, which has been submitted and approved by server 102, as illustrated in FIG. 3F.

A method 230 for improving human relations in system 100 is depicted. In step 232, provider 130 transmits the suggestion based on the core value inputs received from the second user. The suggestion may be a plurality of tips or recommendations that are directly associated with improving components related to the core value inputs that negatively affect the user rating. In one embodiment, the suggestion may be a tutorial, event, video, podcast, course, training session, or any appropriate form of media or series of media configured to assist the first user with improving a core value. For example, if the second user provides a core value that indicates that the first user is unorganized, then provider 130 may provide a suggestion relating to a series of training videos or a training instructor associated with increasing organizational skills. The improvement action may be a type of training course, an event such as a workshop or seminar, or an exercise that must be at least partially completed that is intended to provide a benefit to the user to improve one of the user's core values. Next, in step 234, the first user interacts with the suggestion by participating in an applicable course, training, or workshop. The term “interact” may mean attending, using, doing, completing, working, etc. At step 236, server 102 makes a determination as to whether the first user has completed or otherwise interacted with the provided suggestion. If not, then step 238 occurs in which metrics of the amount of interaction and completion relating to the provided suggestion are generated and transmitted to network 106. If so, then step 240 occurs in which completion data indicating that the first user has fully completed the provided suggestion is generated. In step 242, the user rating may be increased by a predetermined threshold based on the completed suggestion and the applicable core value input. Regardless of the manner of manifestation of the core value input, each core value input of the plurality of core value input includes a number or manner of ranking in order for the input to be included in the calculation and/or statistical models associated with generated the user rating. In one embodiment, the user rating may be increased by a predetermined value based upon receiving the completion data. For example, if the first user's first user rating is 60% or 6 out of ten, and the first user competes for an improvement action, and the system receives the completion data of an improvement action by the first user (potentially from the provider computing device 131, 132, then the system may increase, by a predetermined amount, the first user rating. In one embodiment, the system may be configured to increase the rating by 1 or 1% for each completion data received. In other embodiments, other functions may also be used and are within the spirit and scope of the present invention.

In one embodiment, system 100 includes a messaging component represented by a method 250 in which at step 252, the second user transmits a request to interact message to first user 110. In step 254, the first user receives the request to interact message and decides whether to accept or deny. In step 256, the first user transmits the response to the request to interact message to the second user. In step 258, a determination is made by server 102 as to whether or not the message received by the second user is an approval message. If not, then step 260 occurs in which the second user may not access the user profile or provide core value inputs. If so, then step 262 occurs in which the second user is permitted access to the user profile of the first user and may provide a core value input. In one embodiment, the administrator component is configured to provision whether or not the messaging component is necessary to be established between the first user 110 and second user 120. In one embodiment, acceptance of the message request sent to the first user 110 may be directly associated with a counter related to the amount of activity associated with the user profile (amount of times the user profile is accessed by other users). For example, the system may include counting as a first user interaction each time the first user accepts the approval message from one of the second users and storing the total number of first user interactions in the first user record. This is an important feature because the amount of interactions 343 may be displayed on the user profile so that the user may know how many second users have rated the first user.

In one embodiment, the second user may perform a search, as illustrated by data flow 300, for users of network 106 based on a provided filtering criteria 310, such as, but not limited to, name, geographic location, user rating preference, profession, or any other applicable factor which is applied to one or more search algorithms. The system is configured to calculate the first user listing score for each of the first users matching the filtering criteria received, wherein the first user listing score is a function of the first user rating and user interactions. Based on the provided factors, listing data 312 of applicable users is presented or displayed to the user, including the first user subject to the first user fulfilling a search criterion 310. For example, FIG. 3C1-FIG. 3C4 and FIG. 3E1-FIG. 3E2 illustrate a graphical representation of the listing 390 of users of network 106 wherein user rating 342 is presented based on the second user interacting with a plurality of icons overlaid within a map 330 reflecting the second user's geographic location presented on graphical user interface subject to geographical input data 306 wherein a set radius option and search criteria 310 being provided.

In one embodiment, a user listing score is configured to be presented in a predetermined pattern, which may correspond to each listing score. The user listing score may be the sum of the user rating's numerical value and the total number of first user interactions divided by two. For example, if a first user has a user rating of 40% or 4 out of 10 and 100 interactions with other users, then the user listing score would be 70 ((40+100)/2). However, other calculations may also be used and are within the spirit and scope of the present invention. The listing 390 of users based on the search criteria allows those users with a function of the most interactions and highest first user ratings to be displayed at the top of the list and, as a result, are the users that are most viewable by the searching user. This is important because it allows researching users to interact with people who have higher ratings. This is also an important part of the invention because this allows consumers to want to get better and improve their core values.

In one embodiment, the techniques described herein are implemented by one or more special-purpose computing devices. The special-purpose computing devices may be hard-wired to perform the techniques, or may include digital electronic devices such as one or more application-specific integrated circuits (ASICs) or field-programmable gate arrays (FPGAs) that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, or any other device that incorporates hard-wired and/or program logic to implement the techniques.

For example, FIG. 4 is a block diagram that illustrates a computer system 400 upon which an embodiment of the invention may be implemented. Computer system 400 includes a bus 402 or other communication mechanisms for communicating information and a hardware processor 404 coupled with bus 402 for processing information. Hardware processor 404 may be, for example, a general-purpose microprocessor.

Computer system 400 also includes a main memory 406, such as random-access memory (RAM) 408 or other dynamic storage devices 410, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes read-only memory (ROM) 408 or another static storage device 410 coupled to bus 402 for storing static information and instructions for processor 404. A storage device 410, such as a magnetic disk, optical disk, or solid-state drive, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Typical forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal, and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated service digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or data equipment operated by an Internet Service Provider (ISP) 426. ISP 426, in turn, provides data communication services through the world wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420, and communication interface 418. In the Internet example, a server 102 might transmit a requested code for an application program through Internet 428, ISP 426, local network 422, and communication interface 418.

The received code may be executed by processor 404 as it is received, and/or stored in storage device 410, or other non-volatile storage for later execution.

Although the subject matter has been described in language specific to structural features and/or methodological acts, it is to be understood that the subject matter defined in the appended claims is not necessarily limited to the specific features or acts described above. Instead, the specific features and acts described above are disclosed as example forms of implementing the claims.

What is claimed is:

1. A computer-implemented method for providing human relation improvement, wherein the method comprises:
creating a first user record for a first user and storing first user data associated with the first user in the first user record;
receiving, over a communications network, from a second user remote computing device, first user core value input for each of a plurality of first user core values about the first user;
storing, in the first user record, the first user core value input associated with first user;
calculating the first user rating based on the first user core value input from at least one-second user remote computing device; and,
providing, to at least one of a first user remote computing device and the second user remote computing device, a first user profile having a first graphical representation of the first user rating.

2. The computer-implemented method for providing human relation improvement of claim 1, wherein the first user rating for each first user core value is defined as a first function of the first user core value input received the total number of core values, and the total number of second users providing first user core value input.

3. The computer-implemented method for providing human relation improvement of claim 2, wherein the method further comprises providing, over the communications network to the second user remote computing device, a plurality of second graphical representations each providing an impression related to value for the second user to select to provide the least one first user core value input of the first user and wherein each second graphical representation is assigned a predetermined value.

4. The computer-implemented method for providing human relation improvement of claim 1, wherein the first graphical representation is displayed as a percentage value.

5. The computer-implemented method for providing human relation improvement of claim 4, wherein the first graphical representation is displayed as at least a partially enclosed ring wherein the shape of the ring corresponds with the percentage value.

6. The computer-implements method for providing human relation improvement of claim 2, wherein the second user selects the second graphical representations with a swipe or swiping gesture, push or other means of indicating a second user preference on a screen of the second user remote computing device.

7. The computer-implemented method for providing human relation improvement of claim 1, wherein the method further comprises:
receiving from the second user computing device a request message to interact with a particular first user;
sending to the particular first user's first user remote computing the request message for the first user to at least one of accept and reject the request message to interact;
receiving from the particular first user's first user computing device at least one of a denial message and approval message;
if the denial message is received, then denying access by the second user computing device to the particular first user's first user profile so that the second user cannot provide first user core value input; and,
if the approval message is received, allowing access by the second user computing device to the particular first user's user profile so that the second user may provide first user core value input.

8. The computer-implemented method for providing human relation improvement of claim 7, wherein the method further includes counting as a first user interaction each time the first user accepts the approval message from one of the second users and storing the total number of first user interactions in the first user record.

9. The computer-implemented method for providing human relation improvement of claim 8, wherein the system further comprises:
receiving filtering criteria, over the communications network, from the second user remote computing device;
determining the first users matching the filtering criteria received;
calculating a first user listing score for each of the first users matching the filtering criteria received, wherein the first user listing score is a second function of the first user rating and user interactions; and,
displaying on at least one of the first user remote computing device and second user remote computing device, a list of first users profiles matching the filtering criteria and wherein the list is arranged in a predetermined pattern corresponding to each first user listing score.

10. The computer-implemented method for providing human relation improvement of claim 1, wherein the first user data comprise at least one of a first user first name, a first user last name, a first user telephone number, a first user email address, a first user physical mailing address, and, a first user password, a first user occupation, a first user age and a first user sex, number of first user interactions and a first user listing score.

11. The computer-implemented method for providing human relation improvement of claim 1, wherein the first user rating is not provided to, at least one of the first user computing device and second user computing device until first user core value input is received from at least a predetermined minimum threshold of second user remote computing devices.

12. The computer-implemented method for providing human relation improvement of claim 1, wherein the method further increasing, by a predetermined amount, the first user rating upon receiving completion data of an improvement action by the first user.

13. The computer-implemented method for providing human relation improvement of claim 12, wherein an improvement action is at least one of a course, an event, and an exercise.

14. The computer-implemented method for providing human relation improvement of claim 12, wherein the completion data is provided by a provider remote computing device.

15. A computer-implemented method for providing human relation improvement, wherein the method comprises:
creating a first user record for a first user and storing first user data associated with the first user in the first user record;
receiving, over a communications network, from a second user remote computing device, first user core value input for each of a plurality of first user core values about the first user;
storing, in the first user record, the first user core value input associated with first user;
calculating the first user rating based on the first user core value input from at least one-second user remote computing device;
providing, to at least one of a first user remote computing device and the second user remote computing device, a first user profile having a first graphical representation of the first user rating, and,
providing a plurality of second graphical representations, each suggesting an impression related to value for the second user to select to provide the least one first user input of the first user and wherein each second graphical representation is assigned a predetermined value.

16. The computer-implemented method for providing human relation improvement of claim 15, wherein the first user rating for each first user core value is defined as a first function of the first user core value input received the total number of core values, and the total number of second users providing first user core value input.

17. The computer-implemented method for providing human relation improvement of claim 15, wherein the method further increasing, by a predetermined amount, the first user rating upon receiving completion data of an improvement action by the first user and wherein an improvement action is at least one of a course, an event and an exercise.

18. The computer-implemented method for providing human relation improvement of claim 15, wherein the method further comprises:
counting as a first user interaction each time the first user accepts an approval message from one of the second users and storing the total number of first user interactions in the first user record;
receiving filtering criteria, over the communications network, from the second user remote computing device, wherein the filtering criteria comprises at least one of the first user data;
determining the first users matching the filtering criteria received;
calculating a first user listing score for each of the first users matching the filtering criteria received, wherein the first user listing score is a second function of the first user rating and user interactions; and,
displaying on at least one of the first user remote computing device and second user remote computing device, a list of first users profiles matching the filtering criteria and wherein the list is arranged in a predetermined pattern corresponding to each first user listing score.

19. A system, over a communications network, for providing human relation improvement, wherein the system comprises:
a database for storing a plurality of at least first user records;
a memory;
a processor configured for:
creating the first user record for a first user and storing first user data associated with the first user in the first user record;
receiving, over a communications network, from a second user remote computing device, first user core value input for each of a plurality of first user core values about the first user;
storing, in the first user record, the first user core value input associated with first user;
calculating the first user rating based on the first user core value input from at least one-second user remote computing device; and,
providing, to at least one of a first user remote computing device and the second user remote computing device, a first user profile having a first graphical representation of the first user rating;
providing, a plurality of second graphical representations each suggesting an emotion for the second user to select to provide the least one first user core value input of the first user and wherein each second graphical representation is assigned a predetermined worth; and,
increasing, by a predetermined amount, the first user rating upon receiving completion data of an improvement action by the first user.
